(19) United States
(12) Patent Application Publication
(10) Pub. No.: US 2009/0097617 A1
(43) Pub. Date: Apr. 16, 2009

(54) MODULAR, IMAGING, LARGE X-RAY DETECTOR

(76) Inventor: Peter Kruger, Dresden (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/237,942

(22) Filed: Sep. 25, 2008

(30) Foreign Application Priority Data
Sep. 25, 2007 (DE) 10 2007 045 799.7

(51) Int. Cl. G21K 5/10

(52) U.S. Cl. 378/146

(57) ABSTRACT

The present invention relates to an area X-ray detector for the taking of a projectional radiographic X-ray image of an object exposed to X-ray radiation, comprising an areal X-ray image memory screen (1) made for the detection of the projectional radiographic X-ray image and a plurality of scanning modules (2-1, 2-2, . . . ) made for the scanning of the X-ray image memory screen, with at least two of the plurality of scanning modules each having:

a laser (2a-1, 2a-2, . . . ) made to excite fluorescent light in the X-ray memory screen;

a coupling unit (2b-1, 2b-2, . . . ) made for the coupling of the laser beam which can be generated or is generated by the laser of this scanning module onto a partial area (T-1, T-2, . . . ) of the X-ray image memory screen and for the scanning of this partial area by the coupled laser beam;

a decoupling unit (2c-1, 2-c-2, . . . ) made for the reception and for the collimation of the fluorescent light which can be generated and/or is generated by at least one partial section of the partial surface (T-a1, T-2, . . . ) irradiated and scanned by the laser and associated with said scanning module; and

a detection unit (2d-1, 2d-2, . . . ) made for the spatially resolved detection of the fluorescent light generated in the partial area (T-1, T-2, . . . ) associated with this scanning module and collimated by the decoupling unit of this scanning module).

The present invention relates to an area X-ray detector for the taking of a projectional radiographic X-ray image of an object exposed to X-ray radiation, in particular of a large object, as well as to a corresponding X-ray detection method.

Imaging X-ray detectors or area X-ray detectors for non-destructive material testing have a typical size of some 100 mm squared. The detector surface therefore has to be put together by a mechanical movement of the detector (so-called measured range expansion) for large objects to be exposed. Such a mechanical movement of the detector is time-intensive, on the one hand, and carries the risk, on the other hand, that the individual tiles (i.e. the individual shots of an object zone taken at defined points) will have a different exposure due to intensity fluctuations of the X-ray source. In the assembly of the image of the object from the individual image tiles, this gives rise to the difficulty of fluctuations in intensity or gray scale values from image tile to image tile. Large detectors for mechanical movement are, however, usually only available as line detectors or as line stack detectors. With such detectors, the object has to be led past the detector (or vice versa) in a suitable manner, which is in turn time-intensive and bears the risk of artefacts.

It is thus the object of the present invention to provide an area X-ray detector with which the X-ray image of a large object to be exposed can be taken in a simple, fast and artefact-free manner. It is furthermore the object of the present invention to provide a corresponding X-ray detection method.

The object described above is solved by the area X-ray detector in accordance with claim 1 and by the X-ray detection method in accordance with claim 18. Advantageous embodiment variants of the area X-ray detector in accordance with the invention or of the X-ray detection method in accordance with the invention can be seen from the respective dependent claims. Uses in accordance with the invention are described in claim 21.

The present invention will now initially be described generally, then with reference to an advantageous embodiment. The individual features such as occur in the specifically described combination in the embodiment presented can, however, also occur or be used within the framework of the professional knowledge of the skilled person and within the framework of the present invention also in a different combination.

Major and fundamental features of the area X-ray detector in accordance with the invention are that an X-ray memory screen (image memory screen) able to be made in any size is used for the detection of the projectional radiographic X-ray image of an object exposed to X-rays and the system is made such that the image scanning procedure of the memory screen (as will be described in more detail in the following) already takes place during the taking of the image. A further essential aspect is that the presented area X-ray detector in accordance with the invention has a modular structure, that the area of the X-ray memory screen (hereinafter also just: memory screen) to be scanned is split into a plurality of partial areas (which also preferably do not mutually overlap) and that a scanning modules is associated with each of these partial areas for the scanning of the corresponding partial area.

The scanning in the individual modules preferably takes place using lasers by 2D microscanner mirrors with a corresponding optical coupling and decoupling system. They allow a very fast scanning of the corresponding partial region or of the corresponding partial area so that the memory screen always remains ready to receive.

The fundamental image taking process with the area X-ray detector in accordance with the invention essentially comprises five steps: The X-ray radiation attenuated by the object is absorbed in the absorber (image memory screen). In the image memory screen, the deposited dosage is then converted into a different form of energy (fluorescent light) which is then converted into an electrical signal. The electrical signal is integrated in an analog or digital manner to obtain an image sufficiently free of noise. The image integrated in the detector, that is, as described in more detail below, in the individual scanning modules operating parallel to one another when considered in time, is then transferred to a control computer.

To obtain a gap-free detector, in accordance with the invention, a throughgoing image memory screen is used as the absorber layer. It readily absorbs the X-ray radiation attenuated by the object and has already been examined very much with respect to its absorption properties. On the other hand, such an image memory screen provides the possibility of the analog integration of the information which is utilized in the concept proposed here in accordance with the invention.

Such memory screens are read in that an intense laser excites the fluorescence of the color centers formed by X-ray radiation. With the detector in accordance with the invention presented here, the image scanning procedure (scanning of the color centers by means of laser) is already carried out during the taking of the image (that is, during the radiation of the X-ray radiation onto the memory screen). The individual lasers of the scanning modules are advantageously realized in the form of 2D microscanner mirror arrangements or also in the form of controlled xy-scanners, which were advantageously manufactured monolithically, so that the partial areas associated with them and thus the whole image can be scanned in parallel. Detectors with 2D microscanner mirror arrangements preferably scan the partial areas on the memory screen associated with them in the form of the Lissajous figures known to the skilled person. The scanning can in particular take place at scanner frequencies in the range of some 100 Hz in the case of the use of such detectors so that the memory screen used always remains ready to receive, that is, the image scanning is possible during the taking of the image. In particular semiconductor lasers which can also be introduced in a compact manner into the circuit of the individual scanning modules are suitable as sources or as lasers. The lasers are moved by means of 2D scanners (e.g. 2D microscanner mirror arrangements) such that they each completely scan the partial area of the image memory screen associated with them.

Since the image information is provided in serial form in accordance with the invention by the scanning process, a very fast individual detector (point detector) is advantageously used in the form of an avalanche photodiode in the individual scanning methods to absorb the fluorescent light and to convert it into an electrical signal. To allow the total detector (from all scanning modules) to have an efficiency for X-ray light which is as high as possible, it is necessary to collect as many fluorescence photons as possible. For this reason, an opening angle which is as large as possible is advantageously covered in each scanning module by a large lens in front of the photodiode. In this respect, opening angles larger than 90° are particularly advantageous. These lenses are advantageously manufactured from a material which is highly absorbent of X-ray photos, for example made of lead crystal, barium fluoride and/or of a plastic material containing heavy metal, to protect the receiver units (or the detection units) of the scanning modules, that is, those units which receive the visible photons, from the X-ray radiation which passes through the absorber layer of the memory screen.

If the individual scanning module is designed such that the laser is also guided through such a lens, the described lens is advantageously designed as a doublet to achieve a chromatic adaptation (removal of the chromatic aberration). The usual electronics can advantageously be protected by a lead/tungsten diaphragm.

The simultaneous scanning of the X-ray image memory screen during the saving process, i.e. during the radiation of the X-ray radiation, previously not used in this form, allows a very fast operation of the area X-ray detector in accordance with the invention. In this connection, the memory screen ensures that no image information is lost. Furthermore, due to the use of the laser-readable memory screen, a complex and/or expensive optical imaging system (for example a camera or the like with a sensitive camera chip) such as is used in other detectors is dispensed with.

The serial signal generated in the individual scanning modules by the scanning of the fluorescent light is converted in an A/D process and is accumulated in the scanning module in a two-dimensional memory in accordance with the then actual scanner position. To avoid digital cross-talk of the individual pixels in the memory, this is advantageously done at a higher resolution than the detector ultimately has. Such a binning process is well known to the skilled person; binning factors in the range from 2 to 10 are preferably selected here. The binning to the final resolution is advantageously effected directly before the readout into the readout memory.

The large detector or area X-ray detector in accordance with the invention not only has a large geometrical size, but also a significant number of pixels. It is thus advantageous for this modular detector in accordance with the invention to provide a four-sided tileability such as will be described in even more detail in the following. The connection technology used can already require the correct orientation of the modules. Each module is here advantageously (see the following) constructed in an “AABB” shape, with only A fitting into B (key-lock pairs). Such a connection can be used to carry out the data transport of the received or generated signals, but can also be used to ensure the power supply of the individual scanning modules.

In this connection, each scanning module can advantageously have a certain “intelligence” in that, for example, an image post-processing unit is formed in each module which already carries out steps of the data pre-processing (for example creation of a 2D histogram, the described binning, filter operations such as edge raising or similar, light or dark image correction, . . . ). On the other hand, such an “intelligence” can advantageously be used to form the modules such that they independently organize the data transmission between themselves or between one another (this therefore does not have to be carried out by a central computing unit or similar). This is possible in a simple manner since each module can recognize directly on the basis of the advantageous connection technique whether a further module was plugged to one of its connections (A or B). The data quantity of such an individual scanning module can in this respect be selected to be comparatively small (for example 100*100=10,000 pixels) so that a plurality of the necessary or advantageously provided pre-processing routines can advantageously already be carried out on the processors of the individual scanning modules (for example the aforesaid filtering or similar).

The area X-ray detector in accordance with the invention (or the X-ray detection method in accordance with the invention) has a series of substantial advantages with respect to the known area X-ray detectors:
large detectors such as are needed in the security field also become possible, above all when considered from the price angle, by the use of one and the same module type as scanning modules in a multiple number;
essentially a screen (memory screen) is used as the absorber material which can thus be manufactured in any desired size and can be cut to size simply and in a cost-effective manner. A replacement is also possible in a simple manner as required;
the modular design with the key-lock connection between the individual scanning modules (see the following) on the one hand allows an autoconfiguration of the total detector; on the other hand, a comparatively simple repair of individual defective scanning modules;
a data pre-processing is already possible in the detector hardware by the use of “intelligent” modules, i.e. by the provision of corresponding processing units (for example image post-processing units) in the individual scanning modules;
a data recording without dead time is possible due to the use of the image memory screen;
in particular, it is only the memory screen which offers the advantage that the data recording can continue to take place (by integration) during the data readout).

The present invention will now be explained in the following only with reference to an advantageous embodiment:

There is shown in this respect:

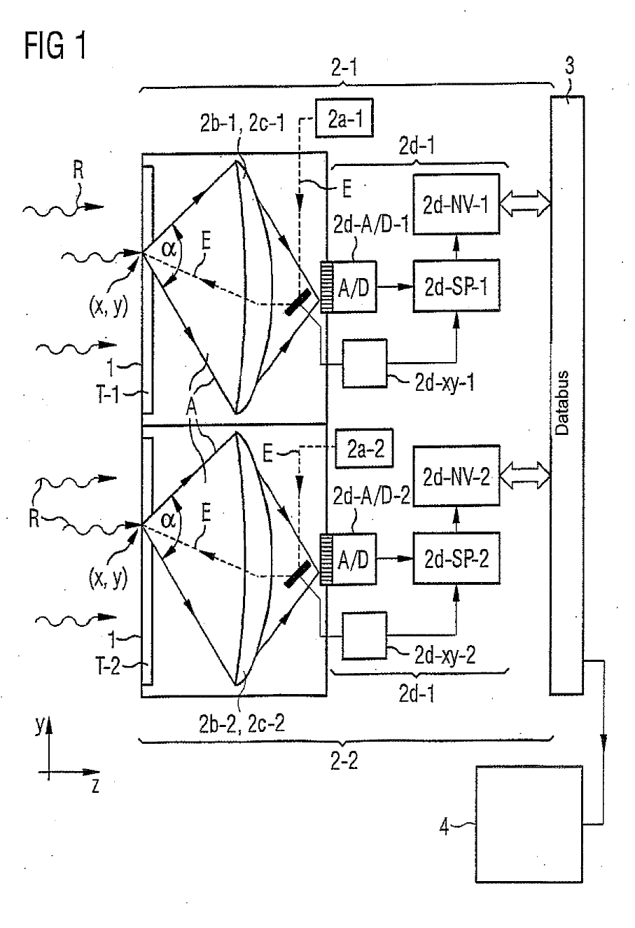

FIG. 1 the structure of two individual scanning modules in accordance with the invention of the area X-ray detector in accordance with the invention (modules 2-1 and 2-2; with a real detector, a plurality of such modules are used adjacent to one another, which is not shown here for reasons of clarity);

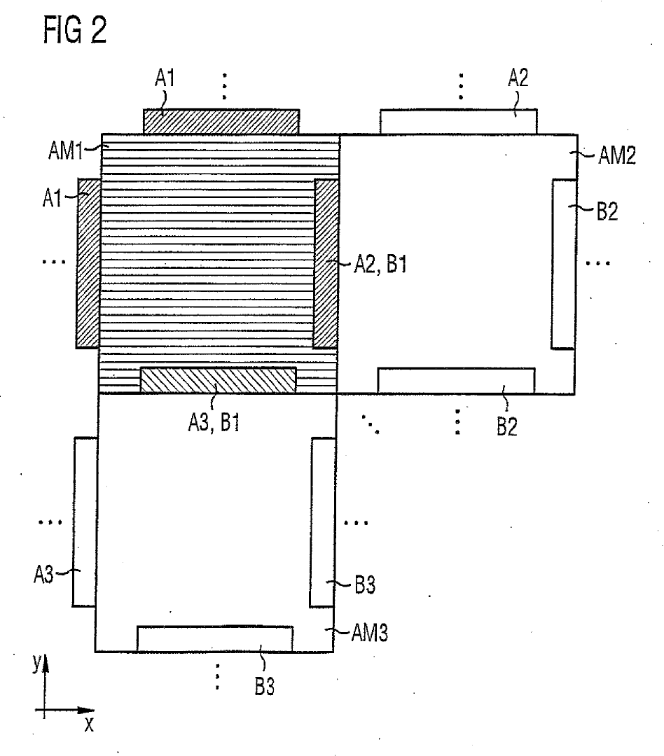

FIG. 2 how the individual modules can be connected or interconnected.

FIG. 1 outlines the basic structure of an embodiment of an area X-ray detector in accordance with the invention. The X-ray radiation R attenuated by an object (not shown) impacts a large-area, non-divided X-ray memory screen 1. This X-ray image memory screen 1 is divided into a plurality of individual partial areas T-1, T-2, . . . (only two shown here). A scanning module 2-1, 2-2, . . . is associated with each of these partial areas, as will now be described in detail in the following. The “division” of the X-ray sensitive surface of the memory screen 1 is to be understood in this respect such that the individual partial areas T-1, T-2, . . . of the memory screen 1 are in each case excited and read out by different scanning modules 2-1, 2-2, . . . . A further division is not necessary. The individual partial areas ideally do not overlap in this respect and completely cover the total surface of the memory screen.

One of the plurality of scanning modules will now be described in its configuration in the following (scanning module 2-1). The other scanning modules (only two shown here) have the same structure. In the operation of the X-ray detector, all the scanning modules are operated in parallel with one another, i.e. during the irradiation of the memory screen 1, all the scanning modules scan their partial areas respectively associated with them in parallel with one another considered from a time aspect.

The scanning module 2-1 has a semiconductor laser 2a-1 made for the excitation of the fluorescent light in memory screen 1. The laser light of this laser is radiated onto a convex doublet lens with the help of a mirror tiltable by means of an XY displacement unit 2d-XY-1 into two spatial directions disposed orthogonally to one another and is projected by means of said convex doublet lens onto the respective position (x, y) of the partial area T-1 of the memory screen 1 to be read out. The XY-displacement unit together with mirror and the associated convex doublet lens in this respect form the coupling unit 2b-1 of the scanning module 2-1: The coupled light E is thus focused onto the location (x, y) of the partial area T-1 to be read out and there generates fluorescent light in accordance with the previously stored X-ray information. The fluorescent light generated (decoupled light A) is collected by the convex doublet lens at an opening angle of approximately 90° (opening angle α), is focused onto an avalanche photodiode and is transformed in an A/D converter 2-A/D-1 into a digital signal. In the present case, the convex doublet lens thus also forms the substantial subassembly of the decoupling unit 2c-1 (optionally, still further optical elements are necessary to realize an ideal decoupling).

The local fluorescent light signal transformed into a digital signal by the A/D converter 2d-A/D-1 is stored in accordance with the position (x,y) instantaneously read out on the partial surface T-1 in a 2D histogram memory 2d-SP-1. The 2D histogram memory 2d-SP-1 thus contains the intensity information stored on the “image pixels” (x, y) of the partial area T-1 of the memory screen 1 in spatially resolved form.

An image post-processing unit 2d-NV-1 (here computer assisted or containing a CPU as well as corresponding registers) is connected after this 2D histogram memory. This image post-processing unit 2d-NV-1 is made to carry out image post-processing operations such as the carrying out of filter operations (for example edge filters) or of light image corrections or dark image corrections using the recorded image information data or intensity values I (x, y) which are stored in the 2D histogram memory 2d-SP-1. The image post-processing unit is also made such that the previously described binning for the final resolution can be carried out with it. The intensity values I_{NV}(x, y) processed by the image processing unit 2d-NV-1 are subsequently output onto a databus 3.

The A/D converter 2d-A/D-1, the XY-displacement unit 2d-XY-1 (which also ensures the association of the individual scanned fluorescent intensities with the scanned location (x, y) in the memory 2d-SP-1 in addition to the control of the coupling mirror for the coupling of the laser light 2a-1), the 2D histogram memory unit 2d-SP-1 and the image post-processing unit 2d-NV-1 form the detection unit 2d-1 of the first scanning module 2-1.

The further scanning modules (only the scanning module 2-2 is shown) of the area X-ray detector are made exactly as has been described for the scanning module 2-1. The image intensity values thus scanned jointly by all scanning modules parallel to the recording of the X-ray information are transmitted to the external computer unit 4 (for example a PC with monitor) via the common databus 3 which forms, together with an external computer unit 4, an integration unit (which can supply the totality of all image signal values to further processing and/or can carry out this processing). The total image (compiled from the partial area image signal values respectively recorded by the individual scanning modules) can be observed on this image presentation unit 4.

The individual scanning modules are designed in the example presented in the form of detectors with 2D microscanner mirror arrangements. The coupling mirrors of the coupling units 2b-1, 2b-2, . . . are tilted by application of two different frequencies into two mutually orthogonal spatial directions by means of the XY-displacement units (as is familiar to the skilled person) and are thus controlled such that the partial areas T-1, T-2, . . . of the individual scanning modules are each scanned completely in the form of Lissajous figures. As described above, this enables a very fast, complete scanning of the individual partial areas so that the scanning can take place simultaneously with the X-ray image recording in the memory screen. The detection of the fluorescent light emitted by the X-ray image memory screen 1 in this respect takes place (before the AD conversion of the corresponding signal) by means of an avalanche photodiode which is likewise familiar to the skilled person in its specific embodiment and which, as previously described, enables the fast scanning.

FIG. 2 outlines how the individual scanning modules of the inventive area X-ray detector shown in FIG. 1 can be plugged together and interconnected. In this respect, a section is shown through a plurality of individual scanning modules (only three scanning modules AM1 to AM3 are shown) in a plane parallel to the memory screen plane. The individual scanning modules have a quadratic (generally: rectangular) shape in this sectional plane x-y; if their extent in the third spatial direction (z direction perpendicular to the plane shown here, cf. also FIG. 1) is included, the individual scanning modules are cuboid (generally: of parallelepiped form) in design. Each of the scanning modules now has one respective connection element A, B at its four outer faces which extend perpendicular to the plane shown (that is, in the z direction: Two each of these four connection elements of a scanning module are made as plugs A; the other two of these connection elements are made as plug sockets B. In each case, a plug A is made on the one face and a plug socket B on the other oppositely disposed face on two oppositely disposed faces of the aforesaid four faces. The plugs are in this respect made in the form of projections which protrude from the scanning module body and which have plug sockets as recesses in the corresponding surface of the scanning module which are made so that they can receive a plug A in shape matched manner and/or in force transmitting manner.

A modular structure and/or a modular plugging together of individual scanning modules AM is possible by the shown AABB configuration of each of the shown scanning modules AM in which two plugs A are arranged on two surface sides of the four aforesaid surface sides adjacent to on another at a 90° angle and in which two plug sockets B are formed on the two other surfaces sides of the four surface sides likewise adjacent to one another at a 90° angle, with the total X-ray sensitive surface of the memory screen 1 being able to be made for scanning in the form of a tile arrangement of non-overlapping partial areas T-1, T-2, . . . from the individual associated partial areas T-1, T-2, . . . (which are associated with the individual scanning modules) by means of said modular structure and/or of said modular plugging together.

In detail, a data transport of X-ray intensity values detected by the individual scanning modules via the common data bus 3 (cf. FIG. 1) between the individual modules or via adjacent modules to the image representation unit 4 is possibly by one of the plug connection described above which is realized by plugging the plug of a scanning module (for example of one of the plugs A2 of the second scanning module AM2) into a plug socket of an adjacent scanning module (for example one of the plug sockets B1 of the first scanning module AM1 shown). Equally, the energy supply of the individual modules can be regulated via the corresponding plug connections A2, B1, A3, B1, . . . .

It is likewise additionally possible to design the individual scanning modules AM1, AM2, . . . interconnected in the manner described above such that they regulate the transport of the image intensity values detected by the individual modules independently of one another, i.e. without an intervention of or a control via the image presentation unit 4 or a corresponding central control unit being necessary.

A self-organization of the scanning modules is possible due to the intelligence of the individual modules. An individual module can detect simply whether it has an adjacent one. Each module moves data of the adjacent module, e.g. to the right, for the data transport. Modules which do not have a right hand neighbor transmit the data downward. A module only has to communicate to the correspondingly left hand or upper module that it is busy and said left hand or upper module then has to wait. The detector can thus be read out module-wise, first the bottommost line from right to left, then the next line. The last output module to which the data collection station or the integration unit is connected is the one at the bottom right with the named data. The data collection station then compiles the total image.

The data collection station can request the size of the detector via the program present in the modules. For this purpose, the module at the bottom right asks its upper neighbor how many upper neighbors it has; all the right hand modules do this and thus the total module line number is produced; this takes place exactly in the same manner to the left to determine the number of columns. Only simple questions and answers are therefore necessary, which are the same for all modules, to ensure the self-organization.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding German application No. 10 2007 045 799.7, filed Sep. 25, 2007, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. An area X-ray detector for the taking of a projectional radiographic X-ray image of an object exposed to X-ray radiation, comprising
an area X-ray memory screen (1) made for the detection of the projectional radiographic X-ray image; and
a plurality of scanning modules (2-1, 2-2, . . . ) made for the scanning of the X-ray image memory screen, wherein at least two of the plurality of scanning modules each have:
a laser (2a-1, 2a-2, . . . ) made to excite fluorescent light in the X-ray memory screen;
a coupling unit (2b-1, 2b-2, . . . ) made for the coupling of the laser beam which can be generated and/or is generated by the laser of this scanning module onto a partial area (T-1, T-2, . . . ) of the X-ray image memory screen and for the scanning of this partial area by the coupled laser beam;
a decoupling unit (2c-1, 2c-2, . . . ) made for the reception and for the collimation of the fluorescent light which can be generated and/or is generated by at least one partial section of the partial area (T-1, T-2, . . . ) irradiated and scanned by the laser and associated with said scanning module; and
a detection unit (2d-1, 2d-2, . . . ) made for the spatially resolved detection of the fluorescent light generated in the partial area (T-1, T-2, . . . ) associated with this scanning module and collimated by the decoupling unit of this scanning module).

2. An area X-ray detector in accordance with claim 1, wherein at least one of the scanning modules, together with its associated partial area, is made for the simultaneous detection of the projectional radiographic X-ray image by irradiation of this partial area of the X-ray image memory screen by means of an X-ray image of the object and scanning of this partial area of the X-ray image memory screen by irradiation of the laser light and by reception and detection of the fluorescent light generated by at least the partial section of this partial area.

3. An area X-ray detector in accordance with claim 1, wherein at least two of the scanning modules can be connected, in particular plugged mechanically in a shape matched manner and/or in a force transmitting manner and/or can be electrically interconnected with respect to the processing and/or the transport of image signal values generated in them and/or with respect to their energy supply.

4. An area X-ray detector in accordance with claim 3, wherein at least one of the connectable and/or electrically interconnectable scanning modules can be connected and/or electrically interconnected to a plurality of other scanning modules.

5. An area X-ray detector in accordance with claim 4, wherein at least one of the scanning modules connectable and/or electrically interconnectable to a plurality of further scanning modules is substantially of parallelepiped, in particular cuboid shape and is connectable and/or electrically interconnectable at two pairs of its respectively oppositely disposed six surface sides to a total of four further scanning modules.

6. An area X-ray detector in accordance with claim 5, wherein at least one of the pairs of oppositely disposed surface sides carries a plug socket (B) on the one surface side and a plug (A) of a plug connection (A, B) fitting into such a plug socket on the other oppositely disposed surface side.

7. An area X-ray detector in accordance with claim 6, wherein at least one such plug connection (A, B) which can be formed and/or is formed between two adjacent scanning modules is made for the mechanically shaped matched and/or force transmitting connection and/or for the processing and/or for the transport of the image signal values and/or for the energy supply.

8. An area X-ray detector in accordance with claim 3, wherein at least one of the connectable and/or electrically interconnectable scanning modules is made for the organization of the processing and/or of the transport of the image signal values generated in it and/or in a scanning module interconnectable and/or interconnected to it.

9. An area X-ray detector in accordance with claim 1, wherein the coupling unit and the decoupling unit of the scanning module are made as an integrated unit in at least one of the scanning modules.

10. An area X-ray detector in accordance with claim 9, wherein the integrated unit includes a lens or a lens system, in particular a doublet, in particular an achromatic doublet; and/or in that the integrated unit consists of or comprises a material of high X-ray absorption, in particular made of lead crystal, barium fluoride and/or plastic material containing heavy metal.

11. An area X-ray detector in accordance with claim 1, wherein the partial surfaces of the X-ray image memory screen respectively associated with the scanning modules are made to overlap or not to overlap and/or completely cover the total X-ray sensitive area of the X-ray image memory screen.

12. An area X-ray detector in accordance with claim 1, wherein at least one detection unit of a scanning module has an A/D converter (2d-A/D-1, 2d-A/D-2, . . . ) and/or a data memory (2d-SP-1, 2d-SP-2, . . . ) and/or an image post-processing unit (2d-NV-1, 2d-NV-2, . . . ), in particular a CPU assisted image post-processing unit.

13. An area X-ray detector in accordance with claim 12, wherein each scanning module has precisely one A/D converter and/or precisely one data memory and/or precisely one image post-processing unit; or in that a plurality of scanning modules have precisely one common A/D converter and/or precisely one common data memory and/or precisely one common image post processing unit;
and/or
that at least one of the image post-processing units is made for histogram formation from image signal values and/or for edge raising and/or for the carrying out of filter operations and/or for light image correction and/or for dark image correction;
and/or
in that at least one of the image post-processing units is made for the carrying out of binning operations and for the storage of binned image signal values in the data memory.

14. An area X-ray detector in accordance with claim 1, wherein an integration unit made for the joining together of the image signal values generated in the detection units of a plurality of different scanning modules from the fluorescent light respectively detected in spatial resolution.

15. An area X-ray detector in accordance with claim 14, wherein the integration unit has a databus (3) and/or an image representation unit (4).

16. An area X-ray detector in accordance with claim 1, wherein at least one of the scanning modules is made as a detector with a 2D microscanner-mirror arrangement and/or as a monolithically integrated 2D scanner which is in particular made for the resonant or non-resonant writing of an xy pattern or of Lissajous figures onto the X-ray image memory screen.

17. An area X-ray detector in accordance with claim 1, wherein at least one detection unit of a scanning module has an avalanche photodiode;
and/or
in that at least one laser of a scanning module is a semiconductor laser.

18. An X-ray detection method for the taking of a projectional radiographic X-ray image,
wherein an object is exposed to X-ray radiation;
wherein the projectional radiographic X-ray image of the exposed object is detected using an areally made X-ray image memory screen (1); and
wherein the X-ray image memory screen is scanned by means of a plurality of scanning modules (2-1, 2-2, . . . ) in parallel considered under a time aspect,
in that fluorescent light is excited in the X-ray image memory screen per scanning module by means of a laser(2a-1, 2a-2, . . . ) in that the laser beam generated by the laser of the scanning module is coupled onto a partial area (T-1, T-2, . . . ) of the X-ray image memory screen and in that this partial area is scanned using the coupled laser beam;
in that, per scanning module, the fluorescent light generated by at least one partial section of the partial area irradiated and scanned by the laser and associated with the scanning module is received, collimated and decoupled; and
in that the fluorescent light generated and decoupled in the partial area associated with the scanning module is detected in spatial resolution per scanning module.

19. An X-ray detection method in accordance with claim 18, wherein the method is carried out using an area X-ray detector in accordance with one of the preceding apparatus claims.

20. An X-ray detection method in accordance with claim 18, wherein at least one scanning module scans the X-ray image memory screen in the form of Lissajous figures, with the partial area associated with the scanning module preferably being scanned at frequencies of above 200 Hz, particularly preferably at frequencies of above 500 Hz.

21. A method in accordance with claim 18 for the non-destructive material inspection of objects and/or for quality assurance in production.
